(19) United States
(12) Patent Application Publication
(10) Pub. No.: US 2023/0035129 A1
(43) Pub. Date: Feb. 2, 2023

(54) METHOD FOR ALLOCATING PROCESSOR RESOURCE, COMPUTING UNIT AND VIDEO SURVEILLANCE ARRANGEMENT

(71) Applicant: Robert Bosch GmbH, Stuttgart (DE)

(72) Inventors: Tom Koene, Eindhoven (NL); Remy Bohmer, Eindhoven (NL); Samy Naouar, Hertogenbosch (NL)

(21) Appl. No.: 17/788,529

(22) PCT Filed: Dec. 23, 2019
(86) PCT No.: PCT/EP2019/086895

§ 371 Date: Jun. 23, 2022

(51) Int. Cl. G06F 9/50; G06F 9/48; H04N 7/18

(52) U.S. Cl. CPC G06F 9/505; G06F 9/4812; H04N 7/18

(57) ABSTRACT

Method for allocating processor resource of a processor of a computing unit to at least two functions F, F1, F2, F3, wherein each of the at least two functions F, F1, F2, F3 has a quality-of-function, wherein the allocation of the processor resource to the at least two functions F, F1, F2, F3 is based on the quality-of-function, wherein the allocation of the processor resource is an adaptive allocation under runtime feedback 4.

### BACKGROUND OF THE INVENTION

The invention concerns a method for allocating processor resource of a processor of a computing unit to at least two functions.

Today's operating systems and computers are using programs and/or connected devices as functions. Such devices are for example IoT (internet of things) products. Especially surveillance systems such as video surveillance systems are using security cameras and smart sensors as connected devices. For a good and save performance of such systems it is necessary to meet hard requirements in terms of functionality, quality of service and performances of those devices. To meet these requirements, a good CPU resource management has to be applied. Such a CPU resource management is normally done with a predictive static resource model.

The document US 2018/0075311 A1, which seems to be the closest state of the art, discloses a method for allocating processor times for a computing unit in a vehicle system, such as a driver assistant system. This vehicle system has at least two functions for the driver assistant system, whereby the processor times are allocated to the function as a function of a signal that represents a state of the vehicle.

### SUMMARY OF THE INVENTION

This invention affects a method for allocating a processor resource of a processor of a computing unit. Furthermore, the invention concerns a computing unit and a video surveillance arrangement. Preferred and advantageous embodiments are disclosed in the dependent claims, the description and the figures.

The invention concerns a method for allocating a processor resource. The processor resource is a resource of a processor, whereby this processor is for example a processor of a computing unit, a computer or a video surveillance system. The processor resource is for example a processor and/or computing time.

The processor is for example a CPU, a NPU, a GPU or DSP. The computing unit can be a personal computer, a smart device for example a smart phone or a tablet. Alternatively, the computing unit may be a computing arrangement and/or a video surveillance arrangement. The computing unit, especially the processor, is adapted to run at least two functions. The functions could for example run parallel, separate or in a mixed mode. This method is for example a method for a processor resource, especially CPU, reservation. The method for example is adapted as a scheduler, for example a Kernel CPU scheduler.

Each of the at least two functions has and/or comprises a quality of function. The general quality of function is for example a data set comprising datas and/or informations about the quality of function of this function. The quality of functions of different functions are preferably in a similar structure or data set. Especially, the method is provided and/or executed with the quality of functions of the at least two functions. For example, the quality of function is stored in a data storage, for example a cloud or USB-drive.

According to the method the allocation of the processor resource to the at least two functions is based on the quality of functions. The allocation is for example a scheduling of the processor resource. The method especially schedules in which way and/or order the at least two functions are using the processor resource and/or are running. The allocation of the processor resource to the at least two functions is especially adapted as a function of the quality of function, preferably quality of function data set. Preferably, the method is platform independent. Platform independent enables for example a portability of the method to other computing units. Furthermore, the method is not limited to a subset and/or number of functions. This could for example be achieved by a general quality of function, especially structure and/or data set language.

According to the method, the allocation of the processor resource is adapted as an adaptive allocation. Adaptive allocation is especially meant as an allocation with runtime feedback.

The method is preferably adapted as a runtime adaptive resource manager. Especially, the method is adapted as an online processor resource manager and/or scheduler.

The invention is based on the idea of providing an enhanced predictive allocation method. Instead of using typical offline allocation, the usage of a runtime adaptive and/or predictive scheduling is able to maximize the processor resource, especially CPU utilization. Especially, the method is adapted as a cross layer method. A cross layer method is for example a method that is bridging programs and/or open source projects with the underlying Kernel, especially linux Kernel. A cross layer method helps to control the systems degree of multiprogramming and hence the overall resource utilization level.

The invention is furthermore based on the idea to provide a method that solves problems occurring by running a multitasking and/or multifunction system. The problems solved by this methods are that overall system, e.g. the operating system doesn't slow down when more and more functions are called. Especially, no uncontrolled access to the shared and/or limited processor resource is allowed. Therefore, malicious function, for example task or app, would not be able to crash or freeze the computing unit. Furthermore, runtime failures due to resource collisions, leaks or fragmentation issues are reduced and the method is not limited to special functions and/or platforms.

The method is preferable provided as an application, for example java application, and especially as an android open source project.

Preferably, the adaptive allocation considers a workload and/or workload variation of the processor, the processor resource and/or the computing unit. Especially, the allocation considers a dynamical variation of the workload. The runtime feedback is especially used for considering the workload and/or workload variation dynamically. Adaptive is for example meant to allocate the processor resource based on the actual workload. Preferably, the method implements a runtime closed loop feedback mechanism. The runtime closed loop feedback mechanism is especially adapted to allow an efficient scheduling of the CPU resource on each functions quality of service. The runtime closed loop feedback is preferably adapted to take into account a dynamically varying processing workload.

In an advantageous embodiment of the invention the quality of function comprises and/or describes a priority, a nice-number, a time-criticality-information, a interruptability, a function characterization, a performance level, an average framerate, a probability distribution of frame finish times and/or a probability of meeting deadlines. The priority is especially a priority of the function, for example to describe how important it is to run this function, especially if it is a security relevant function. The priority is for example implemented as a discrete priority, alternatively as a continues priority. The quality of function is for example adapted as a nice-number or contains a nice-number. Especially, the nice-number is proportional and/or dependent on the priority. The time-criticality-information describes for example, how important it is, that the time deadline of the function is met. Especially, time-criticality-information is influencing or dependent on the priority and/or nice-number. The interruptability describes for example, if the function is allowed to be interrupted, for example how important it is to run the function to the end. For example, a security relevant function, e.g. streaming of a video, is preferably not interruptable, wherein for example a download of a software update is interruptable. A function characterization is for example a general characterization of the function, for example if it is a security relevant function or a nice-to-have-function. An average framerate is for example comprised in a quality of function for a camera or a video streaming, especially to meet all frames and not to drop any frame. The average framerate is especially a function of the video camera frequency.

The allocation of the processor resource to the functions is in an embodiment based and/or a function of the priorities, the nice-numbers, the time-criticality-informations, the interruptabilities, the function characterizations, performance levels and/or probabilities. Especially, the quality of service can be described as an over-all-performance of the function seen by a user. Particularly to quantitatively measure the quality of service, to main specific matrix particularly related to the video processing application may be considered, for example average framerate, average framedrops, framecapture complete response time and/or interframe capture complete response time.

This embodiment is especially based on the idea of prioritization, for example that high priority functions, like safety and security critical applications have to be priorised to meet the requirements, e.g., maintain an average framerate, minimize framedrops, while providing a tolerable response time to non-time-critical applications.

Preferably, the method comprises, executes and/or allows an interruption of a function. The interruption is for example an unregistration of a function of an allocated processor resource. The interruption is especially adapted as an interruption of a function with higher priority or lower nice-number than the other function. For example, a more security relevant function is possible to interrupt the function and/or to unregister the function with a lower priority. Furthermore, the method can consider, contain and/or allow a start, or execute of a function. The start, execute and/or stop is especially carried out without having side-effects on the rest of the system. For example, under heavy load the method allows that no collapse occurs since functions may be stopped. The start, execute and stop of the function is especially part of the dynamic allocation under runtime feedback.

Especially, the interruption is adapted as a hard constraint. For example, hard constraint is a stopping and/or pausing of the function. After the interruption, especially as the hard constraint, this function can be restarted at its beginning or it can be restarted at the position where it is stopped and/or paused.

The interruption is alternatively adapted as a graceful degradation. A graceful degradation is for example slowing down and/or reducing the amount of processor resource that is allocated to this function. Especially a graceful degradation is the reducing of the priority or a raising of the nice-number of the function. For example, the graceful degradation is a slowing down of the processing of the function and/or reducement of the allocated processor resource. Furthermore, the method can contain and/or comprise a graceful increasement. For example, the function's priority can be increased or nice-number decreased. For example, if a function with a higher priority joins in, a function with a lower priority or a higher nice-number can be interrupted with a hard constraint or a graceful degradation. After the finishing of the function with the higher priority is executed and finished, the interrupted function can be restarted or its priority can be increased or nice-number can be decreased.

In a possible embodiment of the invention, the allocation is based on an earliest deadline first policy (EDF) and/or constant bandwidth server (CBS). Preferably, the method is based on a combination of earliest deadline first and constant bandwidth server. Especially global earliest deadline first can be used as earliest deadline first. Especially, the combination uses three parameters: runtime, deadtime and period. Especially, the method uses the requirement runtime≤deadline≤period. This embodiment is based on the idea that in this combination a safe, secure and efficient allocation is possible, whereby the combination with CBS guarantees non-interference between tasks by threads that attempt to overrun their specific runtime. Alternatively functions can be mapped on separate/different CPU cores, i.e. CPU resource isolation can be temporal (EDF+CBS) or spatial i.e. a dedicated CPU core for a specific function.

In a preferred embodiment of the invention, the allocation takes into account a global processor resource threshold and/or a local function threshold. The global processor threshold is especially a “system stability” threshold that is kept to assure that no system crash or collapse in responsiveness occurs. The possible processor resource is for example the sum of a processor resource that is allowed to be allocated and the global processor resource threshold. The global processor resource threshold is for example between ten and five percent, especially between five and three percent, of the processor results. The local function threshold is for example a threshold that is specific for each function. For example the processor resource allocated to a function is the sum of a needed, e.g. estimated, processor resource of the function and the local function threshold. The local function thresholds can furthermore be the same for every function that is running and/or allocated to the processor resource. For example, the local function threshold can be calculated and/or set as the difference of the total processor resource minus the sum of allocated processor resources for each function, divided by the number of functions.

This embodiment is based on the idea to have some security and stability thresholds to ensure a secure processor resource allocation. Especially, the local function thresholds are calculated and/or adapted dynamically, especially under runtime feedback.

In a possible embodiment of the invention one, some or all of the functions are software applications. For example, the software applications are programs and/or applications (e.g. soft appl) running on the computing unit. The programs and/or software applications are especially using and/or executed with the processor. The software applications can furthermore be software applications or programs on devices, for example video cameras or internet of things devices.

In a preferred embodiment of the invention at least one, some or all functions are event driven software applications. Especially, one, some or all software applications contains or are adapted as a video pipeline. Such an event driven software application, especially video pipeline, preferably contains as quality of a function datas that are dependent or a function of a camera framerate. Especially, functions as a video pipeline have a priority higher than a medium priority. Video pipeline and/or event driven software applications have preferably a high priority, a high time criticality and/or a low interruptability.

An embodiment of the invention comprises or is adapted as an allocation of processor resource to groups. Especially, the method comprises a grouping of functions into groups, whereby the allocation of processor resource is made to those groups. A group can contain one or more functions. For example, the method considers two groups, one group is a high security group, the other one in a low security group, whereby allocation of processor resource is made to the high security groups with a higher priority. For example, video capturing and/or fire detection are functions of high security.

In a preferred embodiment of the invention at least one of the functions is a video surveillance application and/or an application involving video surveillance and/or involving video recording or streaming. Such functions are preferably with a high priority and/or high time-criticality-information. Furthermore, such applications have normally a low interruptability and a high performance computing requirement level. Those functions are especially dependent on the framerate of security cameras.

A further subject of the invention is a computing unit with a processor and with an allocation unit, especially configured to carry out every step of the method for allocating a processor resource of the processor. The computing unit can be a personal computer, a surveillance system, a smart device as a smartphone or tablet. The processor is adapted or contains a CPU, GPU, NPU or DSP. The allocation unit may be adapted as a hardware or a software unit. The computing unit is adapted to run functions, wherein each function has a quality of function. Especially, the functions are adapted as described in the method part above. The processor has a processor resource, for example, the processor resource is a processor time.

The allocation unit is adapted to allocate the processor resource to the function based on the quality of function of the functions. Especially, the allocation unit is adapted to allocate like described in the method for allocating processor resource. The allocation unit is adapted to perform an adaptive allocation. Especially, the allocation unit is adapted to run the allocation under and/or using runtime feedback.

Idea of the computing unit is to provide a computing unit that is stable and ensures an allocation that is dynamically and allows a secure running of functions like video surveillance and/or surveillance applications.

In a preferred embodiment of the computing unit the computing unit has an interface. The interface can be a hardware or a software interface. The interface is adapted for connecting the computing unit to devices. The devices are for example smart devices and especially internet of things devices. In a preferred embodiment, the devices are video cameras, sensors, especially surveillance cameras or surveillance sensors or programs. Preferably one of the function is based, using, recourse to and/or describing at least one of the devices. Idea of the video surveillance arrangement embodiment is to provide a computing unit that ensures connecting and running devices and makes sure that no crash of the processor and/or overload of processor resource occurs.

A further object of the invention is a video surveillance arrangement, comprising the computer unit described before. Furthermore, the video surveillance arrangement preferably comprises devices, smart devices, IoT-devices, cameras or surveillance software, interconnected and/or interconnectable with the computing unit. According to this video surveillance arrangement, at least one function is a video surveillance application and/or at least one of the function describes and/or recourses on a video camera. Idea of this object is to provide a video surveillance arrangement that allows a secure video surveillance since no overload of processing resources can occur, so no crash should occur and the processor recourse is used optimized since the allocation is adaptive under runtime feedback.

A further object of the invention is a computer program, configured to carry out every step of one of the method for allocating a processor resource of the processor and a machine-readable storage medium, especially non-transitory machine-readable storage medium, on which the computer program is stored.

### BRIEF DESCRIPTION OF THE DRAWINGS

Further embodiments and advantages are disclosed in the figures and its description.

FIG. 1 schematic flow chart for an example of the method;

FIG. 2 decision tree for an adaptive resource allocation;

FIG. 3 processor resource back pressure;

FIG. 4 schematic diagram of processor resource reservation

FIG. 5 schematic diagram of resource management components;

FIG. 6a example of a time critical task;

FIG. 6b event driven workloads and timing constrains;

FIG. 7a earliest deadline first without temporal isolation;

FIG. 7b earliest deadline first with temporal isolation;

FIG. 8 flow chart for an example of the method.

### DETAILED DESCRIPTION

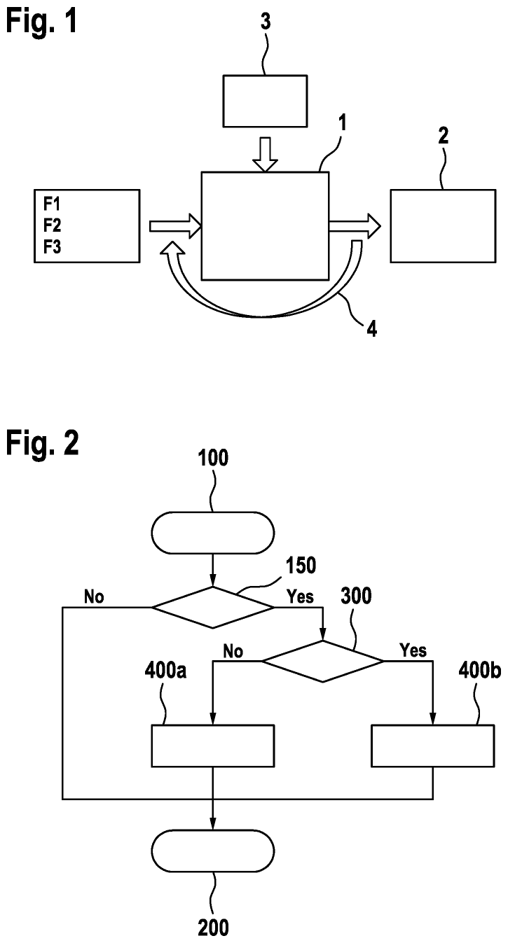

FIG. 1 shows an example of a flow chart for an example of the method according to the invention. The method is carried out with an allocation unit 1. The allocation Unit is for example a program. The allocation Unit is adapted to allocate processor resource of a processor 2 of a computing unit to functions F, for example F1, F2, F3 . . . . The processor 2 is for example a CPU and the allocation unit is allocating CPU times and/or CPU resources to the functions F1, F2, F3. The functions F1, F2, F3 are for example programs or smart devices, that are using or need CPU resource. Each of the functions F1, F2, F3 comprises a quality of function. The quality of function is for example a data set that contains a description of the functions, a priority of the functions, a nice-level or deadline requirements. The functions that want to use processor recourse of the processor 2 are provided to the allocation unit 1. For example, a function F is calling the allocation unit 1 when the function F needs processor resource. The processor 2 has a limited processor resource. Especially, the limited processor resource should not be reached or exceeded, since this could freeze, crash or lead to errors of the function F, processor 2 or computing unit. The allocation unit 1 is provided with the maximum processor resource 3. For example, the maximum processor resource 3 is the real maximum processor resource minus a global processor resource threshold.

Each function F needs a specific processor resource. The needed processor resource of each function F is provided to the allocation unit 1. The allocation unit 1 is adapted to allocate processor resource of the processor 2 to the functions F1, F2, F3. This allocation is done based on the quality of function of each function F. The allocation unit 1 for example allocates the processor resource based on the priority and/or time-criticality of each function F.

The allocation is done under runtime feedback 4. Therefore after allocation the processor resource utilization is measured and provided to the allocation unit 1. Based on the measured processor resource the allocation unit 1 does the allocation for the functions F, here F1, F2, F3 again. By using the runtime feedback 4 it can be ensured that the processor resource of the processor 2 will not be exceeded or reached. For example, if the processor resource, which is utilized by the functions F, is approximating the processor resource limit, the allocation unit 1 can react on this by stopping, pausing or interrupting one of the functions F, F1, F2, F3 so that the processor 2 will not crash. The allocation unit 1 can interrupt one of the functions F, F1, F2, F3, especially based on the quality of a function of these functions, for example interrupt the function with the lowest priority or time-criticality.

FIG. 2 shows a decision tree of an example of the method. In a step 100 the method is started. For example starting of the method can be implemented by starting the computing unit or starting a program. In the step 150 the actual used and/or utilized processor resource is measured and compared to the program's associated local function thresholds, defined for example as the maximum CPU resource utilization for executing the said function (rounded-up or plus some tolerance . . . ). If the measured used processor resource is larger than a set threshold, it is checked in a step 300, if this function or any of the functions using the processor resource is a time-critical task. If it is not a time-critical function, in a step 400a the quality of a function of the not time-critical function is changed. Whereby the quality of a function is changed in the way that its nice-number is increased and/or its priority is reduced. Furthermore, for example in the step 400a the quality of a function can be changed that the scheduling policy of this function should be a CFS-scheduling (complete fair scheduling).

If the function F is a time-critical function in a step 400b its quality of function is changed. Hereby the change of the quality of function is done in the way that its scheduling is set to earliest deadline first and/or its runtime is reduced.

After the steps 400a, 400b and also after step 200 if processor resource is not critical, the cycle of the method ends in a step 200. After this step 200 the method can start again at 100.

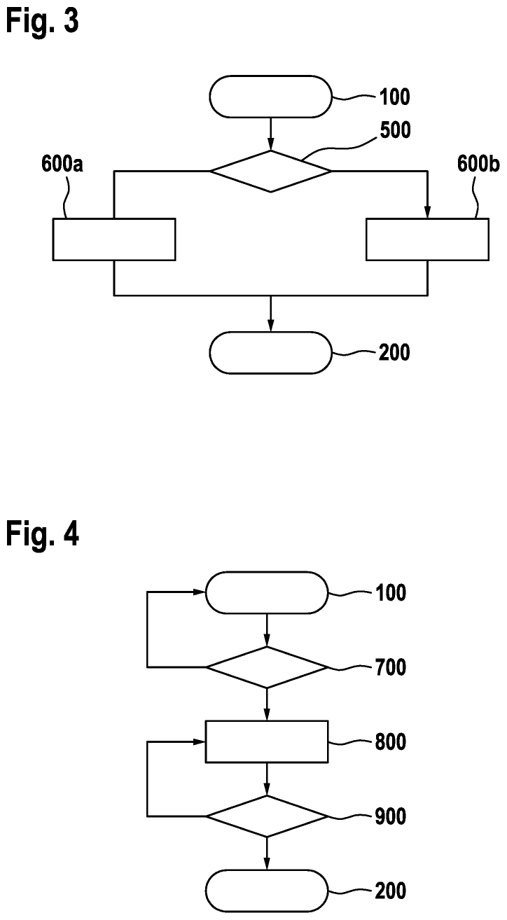

FIG. 3 shows a flow chart of an example for processor resource back pressure semantics. This is especially part of an example of the method. The flow chart and/or this method part starts with the step 100, which is the beginning. In this beginning a new function for example F2 wants to use processor resource and wants to be allocated to the processor 2. A function F1 is already running and allocated to the processor resource. In the step 500 it is checked, if the sum of the needed processor resources of F1 and F2 are larger or equal than the critical and/or maximum processor resource 3. If the sum is less than the maximum resource 3, the function will be allocated to the processor resource and/or the function F2 can successful register at the processor resource. This is done in the step 600a. Furthermore, in the step 600a the scheduling for the function 2 is set to complete fair scheduling.

If in the step 500 it is detected that the sum of the needed resources of F1 and F2 will be larger or equal than the maximum resource 3, in the step 600b it will be denied to the function F2 to register on the processor 2.

Both steps 600a and 600b will be leading to the step 200, which is the end of this allocation. After the end 200 this could start again at step 100.

FIG. 4 shows a flow chart of an example method and/or method part. In the step 100 the flow chart and/or method part starts. In the step 700 it is checked, if the actual processor resource load is larger or equal than the maximum processor resource 3. If it is not larger or equal, the method will start again at 100.

If the actual processor resource load is larger or equal than this limited resource 3, the step 800 will be executed. In the step 800 the functions are analyzed if they are time-critical or not and/or how large their priority is. In the step 800 the priority of a low priority function and/or the priority of a non-time-critical function is reduced. This leads to the step 900, where it is checked, if after this degradation the actual processor resource is still larger than the critical and/or maximum processor resource 3. If it is still larger, than step 800 is executed again. If the actual processor resource load is smaller than this maximum processor resource 3, the method ends at step 200. After step 200 the method can start again at 100.

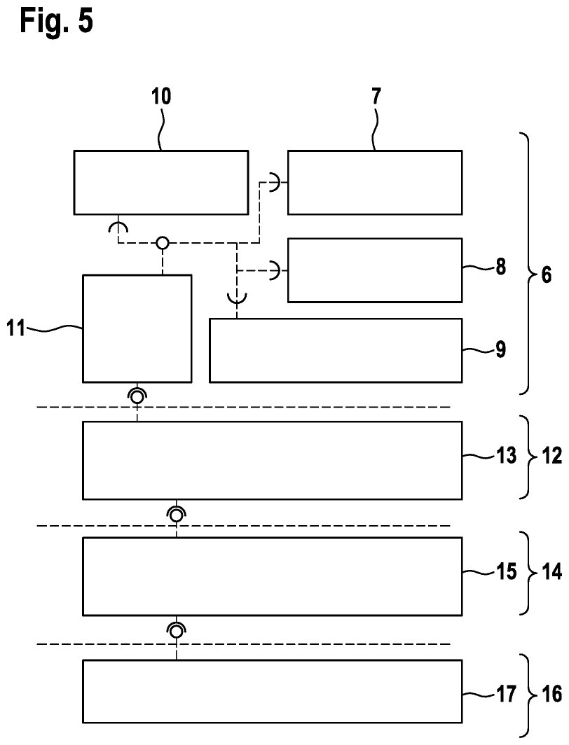

FIG. 5 shows schematically interactions between components of a computing unit. In the application layer framework 6 applications are located and interacting. For example here a video analytics user app 7 with a low priority, a video analytics user app with high priority 8, a video pipeline realtime app 9, a high performance CPU-app 10 and an application manager 11 are located. The application manager 11 starts and stops the applications 7-9. The application framework layer 6 is interconnected with the system layer 12. The system layer 12 is especially connected and/or interacting with the application manager 11. In the system service layer 12 application deployment service 13 is located. The system service layer 12 is interconnected with the hardware abstraction layer 14, where the high-level scheduler 15 is located. The high-level scheduler 15 is especially adapted to run the method of the invention. For example the high-level scheduler 15 is adapted as the allocation unit 1. The hardware abstraction layer 14 is interconnected with a linux Kernel 16 where the CPU-scheduler 17 lies.

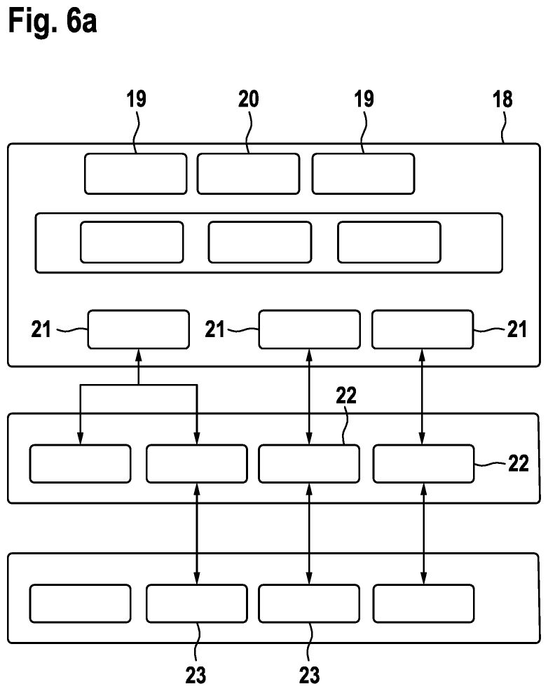

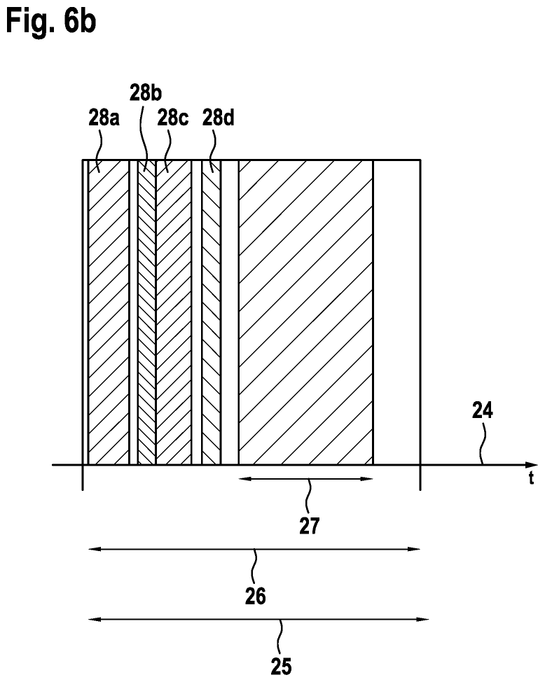

FIG. 6a shows an example of how a time-critical task impacts a video pipeline temporal response. In the app space 18 applications 19 are located. Furthermore, in the app space 18 the video pipeline 20 is located.

Time-critical functions F are defined as workloads that have built in time constrains. This means that not only the result of computation is important, but also the time in which this result is computed is important. Therefore, computation timing constrains for example deadlines, must be taken into a count when deploying time-critical functions.

Such a time-critical function F is for example the video pipeline 20. In the video pipeline 20 not only video stream acquisition, processing and streaming has to be performed, since also the streaming must need a desired average framerate to avoid any frame drop. Capturing and processing a realtime data stream is an event driven workload. So the video pipeline 20 is also an event driven function F. Therefore, the CPU load and/or the processor resource is proportional to the processing rate. The processing rate is dictated by the cameras framerate capturing rate. Therefore, video frame drops can be avoided if the frames processing time for each state in the video pipeline is lower than the video streams time period, for example 33.33 milliseconds for a 30 frames per second camera.

To sustain such a constant rate of computation the method uses low interframe timing variation. This is based on the idea that variation is bad for deterministic scheduling. The delay needs to be minimized. Therefore, support for realtime pre-emptive policies are exposed and supported in the app space 18.

The quality of function of the video pipeline may define its own priority, especially define a high priority. Furthermore, the quality of function of the video pipeline comprises latency constrains for an enabling a more predictable scheduling pattern.

For running the video pipeline 20 not only this has to be executed, also steps and/or processor resource is used concurrently for the hardware abstraction layer applications 21, the kernel space applications 22, for example camera drivers, video codex, and for hardware functions 23 like GPU and imaging pipe. This results in the timeline constrained of FIG. 6b.

FIG. 6b shows an example of a section of a timeline. At the access 24 the time T is used as a scale. For running the video pipeline 20 the allocation unit 1 allocates a time interval 25 to it. The time interval 25 is also called time period. This is the expected and/or allocated time for expecting to finish it. Furthermore, the figure shows the time interval 26, which is called time deadline. Time deadline means that this is the expected completion time. The computation of the expected completion depends not only on functional and/or algorithmic correctness, but is also crucial as a function of time. The time period 27 is called runtime and is the amount of time for executing the video pipe required over the next realtime interval. The bars 28a, 28b, 28c and 28d indicates time that is need for running the functions that are needed for the video pipe for example 28a is time for the hardware applications 23, 28b are the times for Kernel apps 22 and 28c is time for the hardware abstraction layer applications 21.

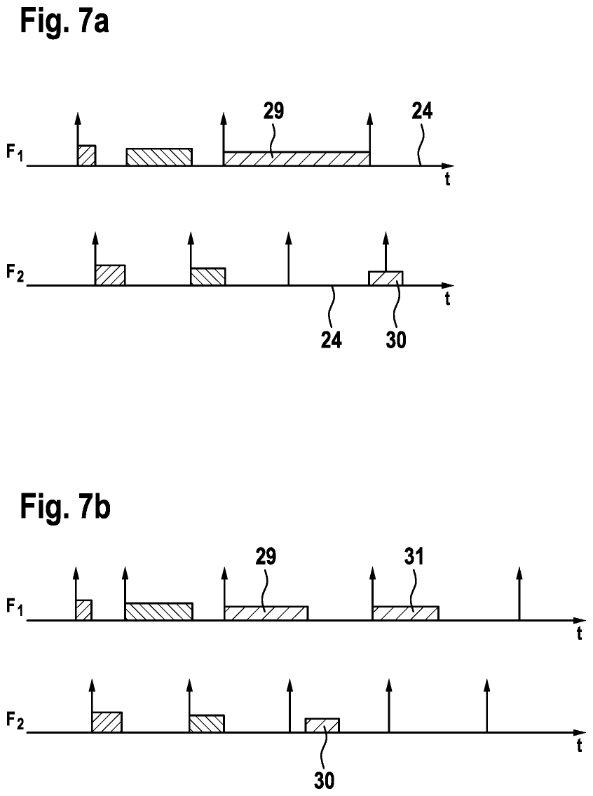

FIG. 7a shows two functions F1 and F2 scheduled for time 24 as processor resource time. The functions F1 and F2 are scheduled as earliest deadline first without a temporal isolation.

The function F1 causes F2 to miss its deadline. The function part 29 has the shown reserved time. If this function consumes more time than allocated it could cause a deadline miss of another task, here task for function F2.

FIG. 7b shows an example of an embodiment of the method, whereby the earliest deadline first scheduling is mixed and/or used with constant bandwidth server mechanism. This guarantees that the task does not eat all available processor resource time and hance cross task interference is minimized. This solution to the problem of FIG. 7a is avoided by suspending the offending task until the next period. By suspending the function part 29 of FIG. 7a into the parts 29 and 31 of FIG. 7b, the function bar 30 of function F2 in FIG. 7a does not miss its deadline like in FIG. 7a.

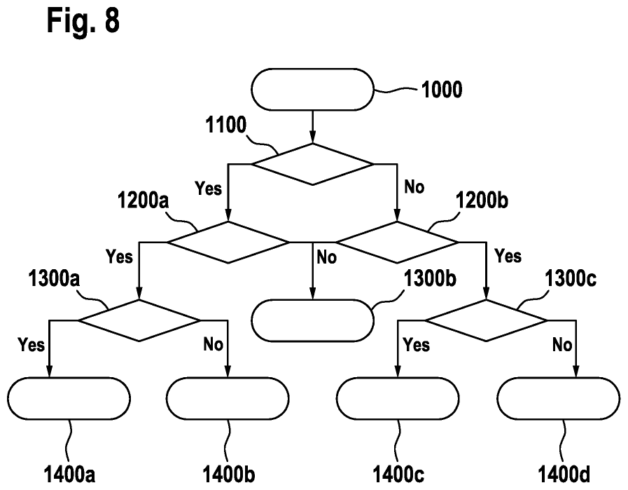

FIG. 8 shows a flow diagram of an example of the method. In step 1000 the method starts. For example the start is triggered by running the processor, the computing unit and/or the surveillance arrangement. In the step 1100 it is checked if the CPU load is larger than a maximum CPU load. The CPU load is the processor resource that is allocated by the method. If the result of step 1100 is that the CPU load is larger than the limited CPU load for example 90 percent, the step 1200a is executed. If the result of step 1100 is that the CPU load is not larger than this 90 percent or limited CPU load, the step 1200b is running.

In step 1200a it is checked, if the function F for example a new and/or new started function or if any of the running functions is a real-time function or not. If it is not a real-time function, the functions or the function is scheduled with CFS policy with a neutral nice value. If the result in step 1200a is that the program is a realtime program, the step 1300a is executed. In step 1300a it is checked if what kind of scheduling policy for example CFS or EDF is carried out. In case 1400a the function is set to CFS with a nice value set to zero. In case 1400b the scheduling of the function is set to earliest deadline first with a maximum threshold.

If in step 1200b it is detected that a scheduling mode is CFS, the step 1300c is executed, whereby if it is detected that the scheduling mode of the function is not CFS, the step 1300b as described before is executed.

In the step 1300c, which means that the CPU load is not larger than 90 percent and the scheduling mode is CFS, it is checked if the maximum threshold is already exceeded. If the result is that the maximum threshold is not exceeded, an average CPU load is computed in step 1400d. If the result is that the maximum threshold is exceeded, than the CFS is reconfigured to a high nice value, thus decreasing the allocated CPU resource scheduling time.

1. A method for allocating a processor resource of a processor of a computer to at least two functions (F, F1, F2, F3), wherein each of the at least two functions (F, F1, F2, F3) has a quality-of-function, the method comprising:
allocating the processor resource to the at least two functions (F, F1, F2, F3) based on the quality-of-function,
wherein the allocation of the processor resource is an adaptive allocation under runtime feedback (4).

2. The method according to claim 1, wherein the adaptive allocation considers a workload of the processor.

3. The method according to claim 1, wherein the quality-of-function is a least one selected from the group consisting of a priority, nice-number, time-criticality-information, interruptability, function characterization, performance level, average framerate, probability distribution of frame finish times, and a probability of meeting deadlines.

4. The method according to claim 1, wherein the allocation comprises an interruption of a function (F, F1, F2, F3) and/or an unregister of a function (F, F1, F2, F3) of an allocated processor resource.

5. The method according to claim 4, wherein the interruption is adapted as a hard constraint.

6. The method according to claim 4, wherein the interruption is adapted as a graceful degradation.

7. The method according to claim 1, wherein the allocation is based on an earliest deadline first and/or constant bandwidth server.

8. The method according to claim 1, wherein the allocation takes a global processor resource threshold and/or a local function threshold into account.

9. The method according to claim 1, wherein at least one of the functions (F, F1, F2, F3) is a software application.

10. The method according to claim 1, wherein at least one of the functions (F, F1, F2, F3) is an event driven software application and/or a video pipeline.

11. The method according to claim 1, wherein some or all of the functions (F, F1, F2, F3) are grouped.

12. The method according to claim 1, wherein at least one of the functions (F, F1, F2, F3) is a video surveillance application.

13. A computing unit having processor (2) and an allocation unit (1),
wherein the computing unit is adapted to run at least one function (F, F1, F2, F3), wherein each function has a quality-of-function,
wherein the processor (2) has a processor resource,
wherein the allocation unit (1) is adapted to allocate the processor resource to the functions based on the quality-of-function of the functions,
wherein the allocation unit is adapted to perform an adaptive allocation under runtime feedback (4).

14. The computing unit according to claim 13, with an interface for connecting with devices, wherein at least one of the functions (F, F1, F2, F3) is based on at least one of the devices.

15. (canceled)

16. A video surveillance arrangement comprising the computing unit according to claim 13, wherein at least one function (F, F1, F2, F3) is a video surveillance application.

17. (canceled)

18. A non-transitory, computer-readable storage medium containing instructions that when executed on a computer cause the computer to
allocate a processor resource of a processor of the computer to at least two functions (F, F1, F2, F3),
wherein each of the at least two functions (F, F1, F2, F3) has a quality-of-function, and
wherein the allocation of the processor resource is based on the quality-of-function and is an adaptive allocation under runtime feedback (4).
